(19) United States
(12) Patent Application Publication
(10) Pub. No.: US 2026/0024363 A1
(43) Pub. Date: Jan. 22, 2026

(54) SEMANTIC SEGMENTATION MODEL TRAINING METHOD, ELECTRONIC DEVICE AND STORAGE MEDIUM

(71) Applicant: Beijing Zitiao Network Technology Co., Ltd., Beijing (CN)

(72) Inventors: Jie QIN, Beijing (CN); Jie WU, Beijing (CN); Ming LI, Beijing (CN); Xuefeng XIAO, Beijing (CN)

(21) Appl. No.: 18/993,522

(22) PCT Filed: Jun. 30, 2023
(86) PCT No.: PCT/CN2023/104539

§ 371 Date: Jan. 10, 2025

(30) Foreign Application Priority Data
Jul. 11, 2022 (CN) 202210814989.4

(51) Int. Cl. G06V 20/70; G06N 3/088; G06N 3/09; G06V 10/82

(52) U.S. Cl. CPC G06V 20/70; G06N 3/088; G06N 3/09; G06V 10/82

(57) ABSTRACT

A semantic segmentation model training method and apparatus, an electronic device and a storage medium are provided. The semantic segmentation model training method includes: acquiring a teacher semantic segmentation model that is pre-trained, the teacher semantic segmentation model including a first teacher network and a second teacher network, the first teacher network having structural characteristics of low depth and high width, and the second teacher network having structural characteristics of high depth and low width; processing a sample image based on the teacher semantic segmentation model to obtain a first segmentation map and a second segmentation map; and training a student semantic segmentation model that is lightweight according to the sample image, the first segmentation map and the second segmentation map, so as to obtain a target semantic segmentation model.

### CROSS-REFERENCE TO RELATED APPLICATION

The present disclosure claims priority of the Chinese Patent Application No. 202210814989.4, entitled “semantic segmentation model training method and apparatus, electronic device and storage medium” and filed with the Chinese Patent Office on Jul. 11, 2022, the entire disclosure of which is incorporated by reference in the present disclosure.

### TECHNICAL FIELD

Embodiments of the present disclosure relate to the technical field of image processing, in particular to a semantic segmentation model training method and apparatus, an electronic device and a storage medium.

### BACKGROUND

Image semantic segmentation is the technique of identifying the content in images to segment objects that represent different meanings into distinct targets, which is commonly achieved by deploying semantic segmentation models trained to perform semantic segmentation on images and is extensively applied in various applications.

In the related art, to enable low-computing-resource terminal devices to achieve image semantic segmentation functionality, it is necessary to train lightweight semantic segmentation models and deploy them on the terminal devices.

### SUMMARY

The embodiments of the present disclosure provide a semantic segmentation model training method and apparatus, an electronic device and a storage medium.

In a first aspect, the embodiments of the present disclosure provide a semantic segmentation model training method, including:
acquiring a teacher semantic segmentation model that is pre-trained, the teacher semantic segmentation model including a first teacher network and a second teacher network, the first teacher network having structural characteristics of low depth and high width, and the second teacher network having structural characteristics of high depth and low width;
processing a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network; and
training a student semantic segmentation model that is lightweight according to the sample image, the first segmentation map and the second segmentation map, so as to obtain a target semantic segmentation model.

In a second aspect, the embodiments of the present disclosure provide a semantic segmentation model training apparatus, including:
an acquisition module, configured to acquire a teacher semantic segmentation model that is pre-trained, the teacher semantic segmentation model including a first teacher network and a second teacher network, the first teacher network having structural characteristics of low depth and high width, and the second teacher network having structural characteristics of high depth and low width;
a processing module, configured to process a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network; and
a training module, configured to train a student semantic segmentation model that is lightweight according to the sample image, the first segmentation map and the second segmentation map, so as to obtain a target semantic segmentation model.

In a third aspect, the embodiments of the present disclosure provide an electronic device, including:
a processor and a memory communicating with the processor,
in which the memory stores computer-executed instructions, and
the processor executes the computer-executed instructions stored in the memory, so as to implement the semantic segmentation model training method described in the first aspect and various possible designs of the first aspect as above.

In a fourth aspect, the embodiments of the present disclosure provide a computer-readable storage medium, in which computer-executed instructions are stored in the computer-readable storage medium, and when the computer-executed instructions are executed by a processor, the semantic segmentation model training method described in the first aspect and various possible designs of the first aspect as above is implemented is implemented.

In a fifth aspect, the embodiments of the present disclosure provide a computer program product, including computer programs, in which the computer programs, when executed by a processor, implement the semantic segmentation model training method described in the first aspect and various possible designs of the first aspect as above.

In a sixth aspect, the embodiments of the present disclosure provide a computer program for implementing the semantic segmentation model training method described in the first aspect and various possible designs of the first aspect as above.

The embodiments of the present disclosure provide a semantic segmentation model training method and apparatus, an electronic device and a storage medium, including: acquiring a teacher semantic segmentation model that is pre-trained, the teacher semantic segmentation model including a first teacher network and a second teacher network, the first teacher network having structural characteristics of low depth and high width, and the second teacher network having structural characteristics of high depth and low width; processing a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network; and training a student semantic segmentation model that is lightweight according to the sample image, the first segmentation map and the second segmentation map, so as to obtain a target semantic segmentation model. By training the student semantic segmentation model with the teacher semantic segmentation model composed of the first teacher network and the second teacher network with differentiated structural characteristics, it is possible to make full use of the features of the first teacher network and the second teacher network, provide learnable knowledge for the student semantic segmentation model from two complementary dimensions (width and depth), and provide knowledge supervision for the training of the student semantic segmentation model.

### BRIEF DESCRIPTION OF DRAWINGS

In order to more clearly illustrate the technical solutions in the embodiments of the present disclosure or in related art, the drawings to be used in the description of the embodiments or prior art will be briefly described below. Obviously, the drawings in the following description are only some embodiments recorded in the present disclosure. For those ordinarily skilled in the art, other drawings may be obtained based on these drawings without inventive work.

FIG. 1 is a diagram of an application scenario of a semantic segmentation model training method provided by an embodiment of the present disclosure;

FIG. 2 is a first flowchart of a semantic segmentation model training method provided by an embodiment of the present disclosure;

FIG. 3 is a structural schematic diagram of a first teacher network provided by an embodiment of the present disclosure;

FIG. 4 is a structural schematic diagram of a second teacher network provided by an embodiment of the present disclosure;

FIG. 5 is a flowchart of specific implementation of step S103 in the embodiment shown in FIG. 2;

FIG. 6 is a schematic diagram of a process for generating a target supervised loss provided by an embodiment of the present disclosure;

FIG. 7 is a second flowchart of a semantic segmentation model training method provided by an embodiment of the present disclosure;

FIG. 8 is a flowchart of specific implementation of step S207 in the embodiment shown in FIG. 7;

FIG. 9 is a flowchart of specific implementation of step S208 in the embodiment shown in FIG. 7;

FIG. 10 is a schematic diagram of a process for acquiring a target unsupervised loss provided by an embodiment of the present disclosure;

FIG. 11 is a structural block diagram of a semantic segmentation model training apparatus provided by an embodiment of the present disclosure;

FIG. 12 is a structural schematic diagram of an electronic device provided by an embodiment of the present disclosure; and

FIG. 13 is a schematic diagram of a hardware structure of an electronic device provided by an embodiment of the present disclosure.

### DETAILED DESCRIPTION

In order to make the objectives, technical solutions, and advantages of the embodiments of the present disclosure clearer, the technical solutions in the embodiments of the present disclosure will be described clearly and completely below in conjunction with the drawings. Apparently, the described embodiments are just a part but not all of the embodiments of the present disclosure. All other embodiments obtained by those ordinary skilled in the art without any creative effort based on the embodiments of the present disclosure fall within the scope of the present disclosure.

The application scenario of an embodiment of the present disclosure will be explained below.

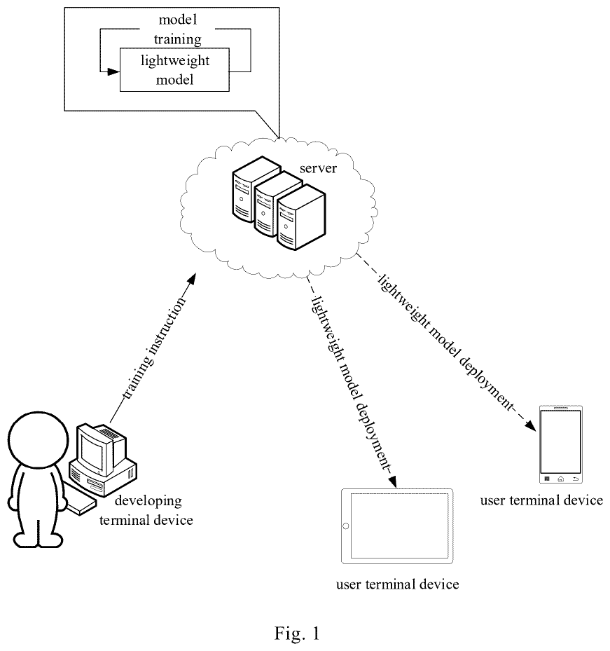

FIG. 1 is a diagram of an application scenario of a semantic segmentation model training method provided by an embodiment of the present disclosure. The semantic segmentation model training method provided by the embodiment of the present disclosure may be applied to an application scenario of model training before a lightweight semantic segmentation model is deployed. Specifically, the method provided by the embodiment of the present disclosure may be applied to devices used for model training, such as terminal devices and servers. FIG. 1 uses server as an example, and as shown in FIG. 1, a teacher semantic segmentation model that is pre-trained and a lightweight student semantic segmentation model to be trained (shown as lightweight model in the figure) are pre-stored in the server. The server receives a training instruction sent by a developer user through a developing terminal device, and uses the semantic segmentation model training method provided by the embodiment of the present disclosure to perform model training on the lightweight model until a model convergence condition is met, so as to obtain a target semantic segmentation model. After that, the server receives a deployment instruction (not shown in the figure) sent by a terminal device, and deploys the lightweight model, that is, deploys the lightweight target semantic segmentation model to the user terminal device. After the deployment is completed, the target semantic segmentation model running in the user terminal device may respond to an application request to provide the image semantic segmentation service.

In the related art, for the training of a lightweight model, knowledge distillation is usually performed by using a pre-trained large model (i.e, teacher model), so that the lightweight model (i.e. student model) can learn knowledge from the large model and realize corresponding model functions. However, in the application scenario of image semantic segmentation, pixel-level image segmentation tasks require high model performance. In the related art, the approach of knowledge distillation using the traditional teacher model often leads to significant performance degradation in a trained lightweight student model, thereby affecting the image segmentation capability, generalization capability, and stability of the student model after training. The training methods in the related art may cause performance degradation in lightweight semantic segmentation models, affecting the normal functionality of the semantic segmentation models. An embodiment of the present disclosure provides a semantic segmentation model training method to solve the above problems.

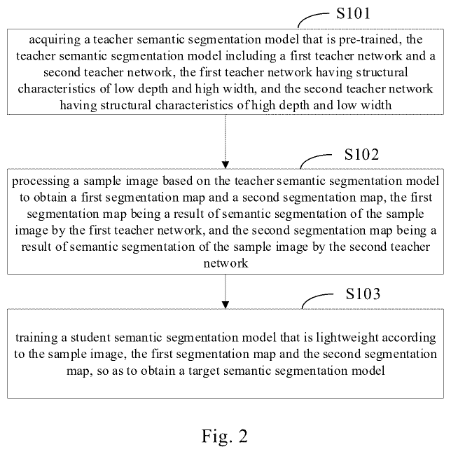

Refer to FIG. 2 which is a first flowchart of a semantic segmentation model training method provided by an embodiment of the present disclosure. The method of this embodiment may be applied to electronic devices with computing capabilities, such as model training servers, terminal devices, etc. In this embodiment, a terminal device is taken as an execution subject, and the semantic segmentation model training method includes:

S101: acquiring a teacher semantic segmentation model that is pre-trained, the teacher semantic segmentation model including a first teacher network and a second teacher network, the first teacher network having structural characteristics of low depth and high width, and the second teacher network having structural characteristics of high depth and low width.

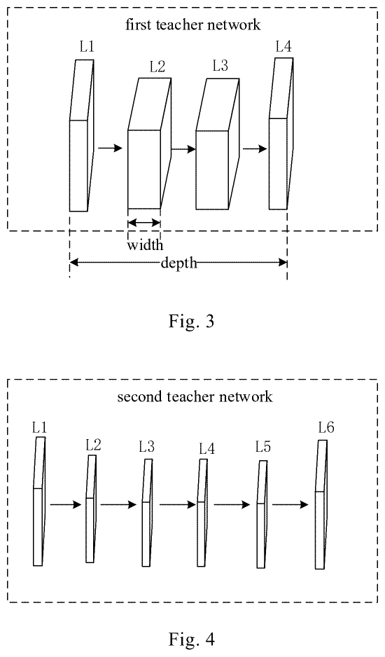

For example, the teacher semantic segmentation model is a pre-trained model with image semantic segmentation capability. Specifically, the teacher semantic segmentation model includes a first teacher network that is pre-trained and a second teacher network that is pre-trained, both the first teacher network and the second teacher network that are trained have image semantic segmentation capability. Here, the first teacher network has structural characteristics of low depth and high width, that is, the first teacher network has a small number of network layers but a large number of network output channels, i.e. a “shallow and wide” network structure. FIG. 3 is a structural schematic diagram of a first teacher network provided by an embodiment of the present disclosure. As shown in FIG. 3, the first teacher network may have an encoder-decoder network structure, which includes four symmetrically arranged network layers (shown as L1, L2, L3 and L4 in the figure). The first teacher network is characterized by low depth, that is, it has a small number of network layers, and is also characterized by high width, that is, the number of channels in the (one or more) network layers is relatively large. For details, please refer to the illustration of “width” and “depth” in FIG. 3.

Correspondingly, the second teacher network has structural characteristics of high depth and low width, that is, the second teacher network has a large number of network layers but a small number of network output channels, i.e, a “deep and narrow” network structure. FIG. 4 is a structural schematic diagram of a second teacher network provided by an embodiment of the present disclosure. As shown in FIG. 4, the second teacher network may have an encoder-decoder network structure, which includes six symmetrically arranged network layers (shown as L1, L2, L3, L4, L5 and L6 in the figure). The second teacher network is characterized by high depth, that is, it has a large number of network layers, and is also characterized by low width, that is, the number of channels in the (one or more) network layers is relatively small. For details, please refer to the illustration of “width” and “depth” in FIG. 3.

Further, for example, a depth-to-width ratio coefficient of the first teacher network is less than or equal to a first threshold, a depth-to-width ratio coefficient of the second teacher network is greater than or equal to a second threshold, the first threshold is less than the second threshold, and the depth-to-width ratio coefficient represents a ratio of a number of network layers to a number of network output channels. The corresponding first threshold and second threshold may be selected according to different business requirements (such as accuracy requirements and real-time performance requirements), and a student semantic segmentation model that is lightweight may be further trained according to the corresponding first teacher network and second teacher network. Here, in one possible implementation, the first teacher network may be a Wide ResNet-34 network, and the second teacher network may be a ResNet-101 network. The specific implementation of the first teacher network and the second teacher network may be set according to specific needs, which is not limited here.

S102: processing a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network.

For example, after the first teacher network and the second teacher network are obtained, a preset sample image is input into the first teacher network and the second teacher network for processing, so that prediction results respectively output by the first teacher network and the second teacher network, that is, the first segmentation map and the second segmentation map, are obtained. Due to the difference in network structure between the first teacher network and the second teacher network, the output first segmentation map and the second segmentation map are also different. Based on its structural characteristics of low depth and high width, the first teacher network has sufficient channels. Therefore, the first teacher network is good at capturing diverse local content perception information, which is helpful for modeling the context relationships between pixels. Based on its structural characteristics of high depth and low width, the second teacher network has more network layers, which is more conducive to extract global information and has capabilities of advanced semantics and global classification abstraction.

Therefore, the first segmentation map output by the first teacher network can better represent local information, while the second segmentation map output by the second teacher network can better represent global information. The processing process of the sample image by the first teacher network and the second teacher network is equivalent to extracting the information in the sample image from two complementary dimensions, and then the lightweight student semantic segmentation model is trained based on the first segmentation map and the second segmentation map, so as to optimize the student semantic segmentation model. In this embodiment, by setting the first teacher network and the second teacher network with two differentiated network structures, information extraction of the image sample is achieved from two complementary dimensions, thus improving the effect of training the student semantic segmentation model.

S103: training a student semantic segmentation model that is lightweight according to the sample image, the first segmentation map and the second segmentation map, so as to obtain a target semantic segmentation model.

For example, the lightweight student semantic segmentation model is a preset small neural network model. The student semantic segmentation model has a very small amount of calculation and parameters, allowing for convenient deployment on resource-limited devices. More specifically, it may be a network model with both low depth and low width. Alternatively, the number of network layers of the student semantic segmentation model may be the same as the number of network layers of the first teacher network.

After obtaining the first segmentation map and the second segmentation map, the process of training the lightweight student semantic segmentation model based on the first segmentation map and the second segmentation map is equivalent to the process of knowledge supervision of the student semantic segmentation model. In this process, the parameters of the first teacher network and the second teacher network are fixed, so this process is a process of improving the performance of the student model by performing offline distillation through the first teacher network and the second teacher network.

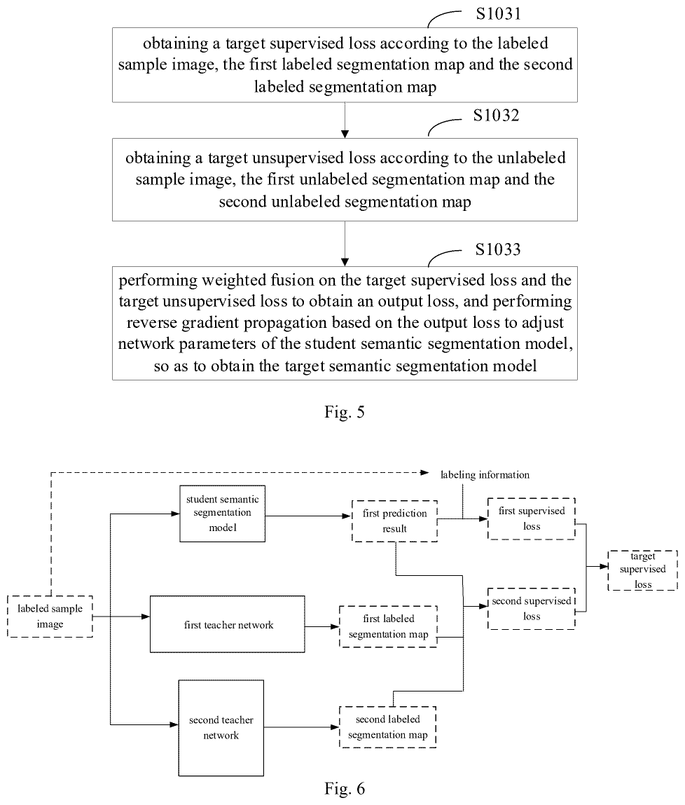

For example, the sample image includes a labeled sample image and an unlabeled sample image; and accordingly, the first segmentation map includes a first labeled segmentation map generated by the labeled sample image and a first unlabeled segmentation map generated by the unlabeled sample image, and the second segmentation map includes a second labeled segmentation map generated by the labeled sample image and a second unlabeled segmentation map generated by the unlabeled sample image. For example, as shown in FIG. 5, the specific implementation of S103 includes:

S1031: obtaining a target supervised loss according to the labeled sample image, the first labeled segmentation map and the second labeled segmentation map.

For example, the labeled sample image is data including an image and corresponding labeling information. By processing the labeled sample image with the student semantic segmentation model, a result of semantic segmentation of the labeled sample image by the student semantic segmentation model is obtained, that is, a first prediction result. Then, for example, based on the first prediction result, the first labeled segmentation map and the second labeled segmentation map, a first supervised loss and/or a second supervised loss may be obtained. Here, the first supervised loss represents a difference between the labeling information and the first prediction result, and the second supervised loss represents a pixel-level consistency difference between the first labeled segmentation map and the second labeled segmentation map relative to the first prediction result. The target supervised loss may be the first supervised loss, the second supervised loss or a weighted sum of the first supervised loss and the second supervised loss.

A method for determining the first supervised loss and the second supervised loss will be introduced below.

For example, a method for calculating the first supervised loss includes: after obtaining the first prediction result, based on a preset supervised loss function, taking the first prediction result, and the labeling information of the labeled sample image as inputs for calculation, so as to obtain the first supervised loss. Here, the specific implementation of calculating the corresponding supervised loss based on the supervised loss function is not further elaborated here.

For example, a method for calculating the second supervised loss includes: after obtaining the first prediction result, using the first labeled segmentation map and the second labeled segmentation map corresponding to the labeled sample image as pseudo labels corresponding to the first prediction result, respectively, to constrain the first prediction result, so as to obtain a corresponding pixel-level consistency difference, specifically, based on a preset labeled data pixel-level consistency loss function, taking the first prediction result, the first labeled segmentation map and the second labeled segmentation map as inputs for calculation, so as to obtain the second supervised loss. Here, the specific implementation of the labeled data pixel-level consistency loss function is shown in Formula (1):

$${L}_{P}^{l} = - \frac{1}{H \times W} {\sum }_{i = 1}^{H \times W} [ {y}_{i} log ( {y}_{pi}^{{T}_{D}} ) + {y}_{i} log ( {y}_{pi}^{{T}_{W}} ) ] \qquad ( 1 )$$

Where yᵢ represents the first prediction result,

$${y}_{pi}^{{T}_{D}}$$

is the second segmentation map corresponding to the labeled sample image,

$${y}_{pi}^{{T}_{W}}$$

is the first segmentation map corresponding to the labeled sample image, H×W represents the total number of pixels of the first prediction result, and

$${L}_{P}^{l}$$

is the second supervised loss.

Because the first teacher network, the second teacher network and the student semantic segmentation model process the same set of labeled sample data, the segmentation results predicted by them should be consistent at pixel level in an ideal state. Through the second supervised loss, the prediction results output by multiple branches may be guaranteed to be consistent, so as to realize auxiliary supervision of the student semantic segmentation model and improve the effect of training the student semantic segmentation model. Then, based on one of the first supervised loss and the second supervised loss, or the weighted sum of the two, the target supervised loss may be obtained, and the specific implementation method may be set as needed, which will not be further elaborated here.

FIG. 6 is a schematic diagram of a process for generating a target supervised loss provided by an embodiment of the present disclosure. As shown in FIG. 6, after labeled image data is input into the first teacher network, the second teacher network, and the student semantic segmentation model, the first teacher network outputs the first labeled segmentation map, the second teacher network outputs the second labeled segmentation map, and the student semantic segmentation model outputs the first prediction result; then the first supervised loss is generated by combining the first prediction result and the labeling information, and the second supervised loss is generated by combining the first labeled segmentation map and the second labeled segmentation map which are taken as the pseudo labels of the first prediction result, and the first prediction result; and

weighted summation is performed on the first supervised loss and the second supervised loss to obtain the target supervised loss.

S1032: obtaining a target unsupervised loss according to the unlabeled sample image, the first unlabeled segmentation map and the second unlabeled segmentation map.

For example, the unlabeled sample image is data which only include an image, but do not include corresponding labeling information. The acquisition cost of unlabeled sample images is lower and the number of unlabeled sample images is larger. Therefore, by extracting the information from unlabeled sample images for thorough training, the performance of the student semantic segmentation model may be improved and the problem of performance degradation of the lightweight student semantic segmentation model may be avoided.

For example, first, by processing the unlabeled sample image with the student semantic segmentation model, a result of semantic segmentation of the unlabeled sample image by the student semantic segmentation model, that is, a second prediction result, is obtained. This process is the same as the process of processing the labeled sample image with the student semantic segmentation model, which will not be repeated here. Then, for example, the first unlabeled segmentation map and the second unlabeled segmentation map are used as pseudo labels corresponding to the second prediction result for loss function calculation, so as to obtain the corresponding target unsupervised loss. In one possible implementation, the target unsupervised loss includes the first unsupervised loss, which represents a pixel-level consistency difference of the first unlabeled segmentation map and the second unlabeled segmentation map relative to the second prediction result.

A method for calculating the first unsupervised loss includes: after obtaining the second prediction result, using the first unlabeled segmentation map and the second unlabeled segmentation map corresponding to the unlabeled sample image as pseudo labels corresponding to the second prediction result, respectively, to constrain the second prediction result, so as to obtain a corresponding pixel-level consistency difference, specifically, based on a preset unlabeled data pixel-level consistency loss function, taking the second prediction result, the first unlabeled segmentation map and the second unlabeled segmentation map as inputs for calculation, so as to obtain the first unsupervised loss. Here, the specific implementation of the unlabeled data pixel-level consistency loss function is shown in Formula (2):

$${L}_{P}^{u} = - \frac{1}{H \times W} {\sum }_{j = 1}^{H \times W} ⌈ {y}_{j} log ( {y}_{pj}^{{T}_{D}} ) + {y}_{j} log ( {y}_{pj}^{{T}_{W}} ) ] \qquad ( 2 )$$

where yⱼ represents the second prediction result,

$${y}_{pj}^{{T}_{D}}$$

is the second unlabeled segmentation map corresponding to the unlabeled sample image,

$${y}_{pj}^{{T}_{W}}$$

is the first unlabeled segmentation map corresponding to the unlabeled sample image, H×W represents the total number of pixels of the second prediction result, and

$${L}_{P}^{u}$$

is the second supervised loss.

S1033: performing weighted fusion on the target supervised loss and the target unsupervised loss to obtain an output loss, and performing reverse gradient propagation based on the output loss to adjust network parameters of the student semantic segmentation model, so as to obtain the target semantic segmentation model.

For example, after obtaining the target supervised loss and the target unsupervised loss, weighted fusion is performed on the target supervised loss and the target unsupervised loss to obtain the output loss. For example, weighting coefficients corresponding to the target supervised loss and the target unsupervised loss may be set based on specific needs and may be dynamically adjusted. For example, in the carly training stage of the student semantic segmentation model, the target supervised loss corresponding to the labeled sample image is set to have a large weighting coefficient to improve the convergence speed of the model, and in the later training stage of the student semantic segmentation model, the target supervised loss corresponding to the unlabeled sample image may be set to have a large (or slightly larger) weighting coefficient, so as to make full use of the information in the unlabeled sample image and improve the performance of the student semantic segmentation model. Then, reverse gradient propagation is performed based on the output loss to adjust network parameters of the student semantic segmentation model, so as to obtain an optimized student semantic segmentation model. The process is repeated until the student semantic segmentation model reaches a convergence condition. The converged student semantic segmentation model is the target semantic segmentation model.

In this embodiment, by processing the labeled data and the unlabeled data, the obtained output loss makes full use of the information in the labeled sample image and the unlabeled sample image; meanwhile, by combining the differential information extraction capabilities of the first teacher network and the second teacher network, the learning capability of the student semantic segmentation model is improved.

In this embodiment, by acquiring a teacher semantic segmentation model that is pre-trained, the teacher semantic segmentation model including a first teacher network and a second teacher network, the first teacher network having structural characteristics of low depth and high width, and the second teacher network having structural characteristics of high depth and low width; processing a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network; and training a student semantic segmentation model that is lightweight according to the sample image, the first segmentation map and the second segmentation map, so as to obtain a target semantic segmentation model, by training the student semantic segmentation model with the teacher semantic segmentation model composed of the first teacher network and the second teacher network with differentiated structural characteristics, it is possible to make full use of the features of the first teacher network and the second teacher network, provide learnable knowledge for the student semantic segmentation model from two complementary dimensions (width and depth), and provide knowledge supervision for the training of the student semantic segmentation model, thus improving the efficiency and effect of training the student semantic segmentation model and improving the model performance of the final generated target semantic segmentation model.

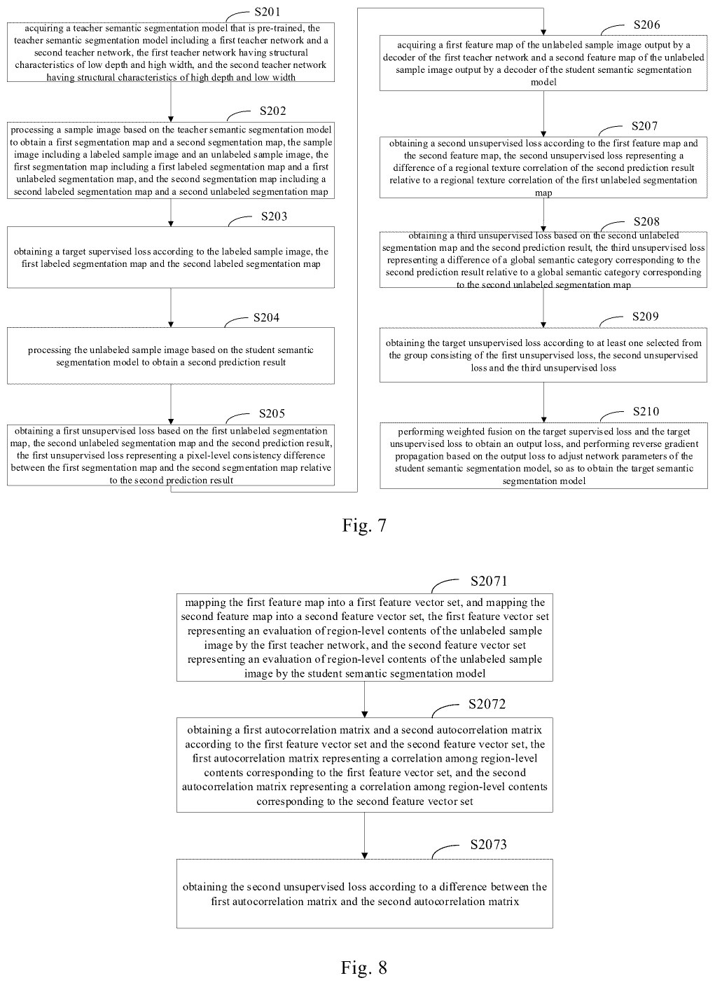

Refer to FIG. 7 which is a second flowchart of a semantic segmentation model training method provided by an embodiment of the present disclosure. This embodiment further refines the specific implementation of S102 on the basis of the embodiment shown in FIG. 2. The semantic segmentation model training method includes:

S201: acquiring a teacher semantic segmentation model that is pre-trained, the teacher semantic segmentation model including a first teacher network and a second teacher network, the first teacher network having structural characteristics of low depth and high width, and the second teacher network having structural characteristics of high depth and low width.

S202: processing a sample image based on the teacher semantic segmentation model to obtain a first segmentation map and a second segmentation map, the sample image including a labeled sample image and an unlabeled sample image, the first segmentation map including a first labeled segmentation map and a first unlabeled segmentation map, and the second segmentation map including a second labeled segmentation map and a second unlabeled segmentation map.

Through steps S201-S202, the labeled sample image and the unlabeled sample image are processed based on the first teacher network and the second teacher network, respectively, to obtain the first labeled segmentation map, the first unlabeled segmentation map, the second labeled segmentation map and the second unlabeled segmentation map. Here, the order of processing the labeled sample image and the unlabeled sample image may be set according to specific needs, which is not limited here. The specific implementation of obtaining the first labeled segmentation map, the first unlabeled segmentation map, the second labeled segmentation map and the second unlabeled segmentation map have been introduced in the embodiment shown in FIG. 2, and will not be repeated here.

S203: obtaining a target supervised loss according to the labeled sample image, the first labeled segmentation map and the second labeled segmentation map.

S204: processing the unlabeled sample image based on the student semantic segmentation model to obtain a second prediction result.

S205: obtaining a first unsupervised loss based on the first unlabeled segmentation map, the second unlabeled segmentation map and the second prediction result, the first unsupervised loss representing a pixel-level consistency difference between the first segmentation map and the second segmentation map relative to the second prediction result.

Here, S203 is a step of obtaining the target supervised loss based on the labeled sample image, which has been introduced in the embodiment shown in FIG. 2. For details, please refer to the related introduction in S1031 corresponding to the embodiment shown in FIG. 2, which will not be repeated here, S204-S205 are steps to obtain the second prediction result and the first unsupervised loss based on the unlabeled sample image, which have been introduced in the embodiment shown in FIG. 2. For details, please refer to the related introduction in S1032 corresponding to the embodiment shown in FIG. 2, which will not be repeated here.

S206: acquiring a first feature map of the unlabeled sample image output by a decoder of the first teacher network and a second feature map of the unlabeled sample image output by a decoder of the student semantic segmentation model.

S207: obtaining a second unsupervised loss according to the first feature map and the second feature map, the second unsupervised loss representing a difference of a regional texture correlation of the second prediction result relative to a regional texture correlation of the first unlabeled segmentation map.

For example, based on the introduction of the first teacher network in the above embodiment, the first teacher network is of an encoder-decoder network structure with structural characteristics of low depth and high width, allowing it to effectively capture diversified local content perception information, which is helpful for modeling the context relationships between pixels. In the steps of this embodiment, by acquiring the first feature map (Features) of the unlabeled sample image output by the decoder of the first teacher network and the second feature map (Features) of the unlabeled sample image output by the decoder of the student semantic segmentation model, the first feature map representing a processing region texture correlation of the unlabeled sample image captured by the first teacher network and the second feature map representing a processing region texture correlation of the unlabeled sample image captured by the student semantic segmentation model, a difference of a regional texture correlation of the second prediction result relative to a regional texture correlation of the first unlabeled segmentation map, that is, the second unsupervised loss (also called region-level content perception loss), is obtained by calculating the first feature map and the second feature map. The region-level content perception loss aims to provide rich local context information by utilizing the wider channel advantage of the teacher model (the first teacher network). It can provide auxiliary supervision to guide the student model (student semantic segmentation model) to model the contextual relationship between pixels. It uses the correlation of image patch regions input into the teacher model to guide an inter-regional texture correlation of the student model.

For example, as shown in FIG. 8, the specific implementation of S207 includes:

S2071: mapping the first feature map into a first feature vector set, and mapping the second feature map into a second feature vector set, the first feature vector set representing an evaluation of region-level contents of the unlabeled sample image by the first teacher network, and the second feature vector set representing an evaluation of region-level contents of the unlabeled sample image by the student semantic segmentation model.

S2072: obtaining a first autocorrelation matrix and a second autocorrelation matrix according to the first feature vector set and the second feature vector set, the first autocorrelation matrix representing a correlation among region-level contents corresponding to the first feature vector set, and the second autocorrelation matrix representing a correlation among region-level contents corresponding to the second feature vector set.

S2073: obtaining the second unsupervised loss according to a difference between the first autocorrelation matrix and the second autocorrelation matrix.

For example, the features (first feature map) of the teacher model (first teacher network) and the features (second feature map) of the student model (student semantic segmentation model) are extracted from a feature space after the decoder. These features (the first feature map and the second feature map) are mapped to feature vector sets V∈R^{C×H}^{ᵥ}^{×W}^{ᵥ} of region-level contents, that is, the first feature map is mapped to a first feature vector set and the second feature map is mapped to a second feature vector set, where Hᵥ×Wᵥ is the number of pixels at region level, and each feature vector v∈R^{C×1×1} in V represents the local region content of an original feature (the local feature size is C×H/Hᵥ×W/Wᵥ). Then, a corresponding autocorrelation matrix M∈R^{H}^{ᵥ}^{W}^{ᵥ}^{×H}^{ᵥ}^{W}^{ᵥ} is obtained through the feature vector set V, and the calculation process is shown in Formula (3):

$$M = sim ( {V}^{T} V ) , with {m}_{ij} = \frac{{v}_{i}^{T} {v}_{j}}{‖ {v}_{i} ‖ ‖ {v}_{j} ‖} \qquad ( 3 )$$

where mᵢⱼ refers to the value located at coordinates (i, j) in the autocorrelation matrix, which is calculated by cosine similarity sim( ), and vᵢ and vⱼ are the i^{th} and j^{th} vectors in the flattened feature vectors V∈R^{C×H}^{ᵥ}^{W}^{ᵥ}. The calculated autocorrelation matrix represents the correlation at feature region level and reflects the relationship between different regions of the image. Therefore, a region-level content perception loss function, that is, the second unsupervised loss, may be obtained by minimizing a difference between autocorrelation matrices of different models. Specifically, the calculation process of the second unsupervised loss is shown in Formula (4):

$${L}_{R}^{u} ( {M}^{S} , {M}^{{T}_{W}} ) = \frac{1}{{H}_{ν} {W}_{ν} \times {H}_{v} {W}_{ν}} {\sum }_{i = 1}^{{H}_{v} {W}_{v}} {\sum }_{j = 1}^{{H}_{ν} {W}_{v}} {( {m}_{ij}^{S} - {m}_{ij}^{{T}_{W}} )}^{2} \qquad ( 4 )$$

where M^{S} is the second autocorrelation matrix, M^{T}^{_{W}} is the first autocorrelation matrix,

$${m}_{ij}^{S}$$

is a value in the second autocorrelation matrix, and

$${m}_{ij}^{{T}_{W}}$$

is a value in the first autocorrelation matrix.

S208: obtaining a third unsupervised loss based on the second unlabeled segmentation map and the second prediction result, the third unsupervised loss representing a difference of a global semantic category corresponding to the second prediction result relative to a global semantic category corresponding to the second unlabeled segmentation map.

Further, for example, based on the introduction of the second teacher network in the above embodiment, the second teacher network is of an encoder-decoder network structure with structural characteristics of high depth and low width. The second teacher network has more network layers, which is more conducive to extract global information and has capabilities of advanced semantics and global classification abstraction. In the steps of this embodiment, after the unlabeled sample image is predicted to obtain the second unlabeled segmentation map and the second prediction result, based on the characteristics of the second teacher network, high-dimensional semantic abstract information is extracted from the deeper second teacher network to the lightweight student semantic segmentation model, thereby improving the performance of the student semantic segmentation model.

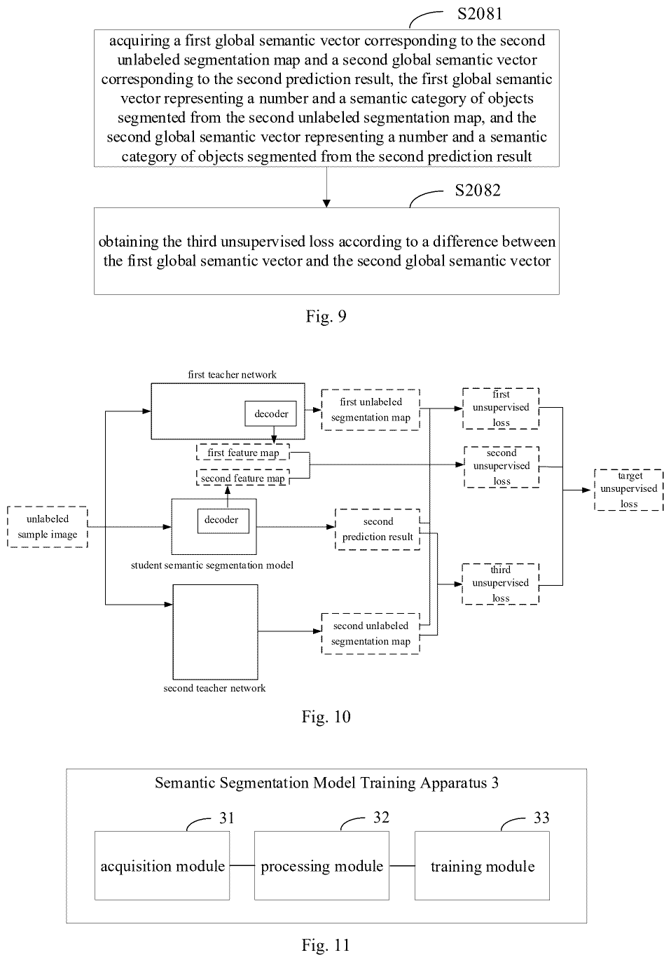

For example, as shown in FIG. 9, the specific implementation of S208 includes:

S2081: acquiring a first global semantic vector corresponding to the second unlabeled segmentation map and a second global semantic vector corresponding to the second prediction result, the first global semantic vector representing a number and a semantic category of objects segmented from the second unlabeled segmentation map, and the second global semantic vector representing a number and a semantic category of objects segmented from the second prediction result.

S2082: obtaining the third unsupervised loss according to a difference between the first global semantic vector and the second global semantic vector.

For example, a global semantic vector of each category is calculated through the global average pooling (GAP) operation. Specifically, the second unlabeled segmentation map is Y∈R^{N×H×W}, and the calculation process of the first global semantic vector is shown in Formula (5):

$${K}_{G}^{{T}_{D}} = G ( Y ∈ {R}^{N \times H \times W} ) \qquad ( 5 )$$

where the first global semantic vector

$${K}_{G}^{{T}_{D}} ∈ {R}^{N \times 1 \times 1}$$

represents a global semantic category vector of N categories, and G represents the global average pooling operation in each channel. Similarly, based on the above Formula (5), the second global semantic vector K_{G}^{S} corresponding to the second prediction result may be obtained by processing the second prediction result, which will not be described in detail.

Then, the third unsupervised loss is obtained by using the difference between the first global semantic vector and the second global semantic vector, and the specific calculation process is shown in Formula (6):

$${L}_{I}^{u} ( {K}_{G}^{S} , {K}_{G}^{{T}_{D}} ) = \frac{1}{N} {\sum }_{i = 1}^{N} {‖ {k}_{Gi}^{S} - {k}_{Gi}^{{T}_{D}} ‖}_{1} \qquad ( 6 )$$

where

$${L}_{I}^{u}$$

is the third unsupervised loss, and

$${k}_{Gi}^{S} and {k}_{Gi}^{{T}_{D}}$$

respectively represent semantic categories output by the student semantic segmentation model and the second teacher network. N represents the number of categories, and the superscript u represents the unlabeled sample image. In this way, the student semantic segmentation model tries to learn higher-dimensional semantic category representation, which helps to provide global guidance for semantic category discrimination in semantic segmentation tasks.

S209: obtaining the target unsupervised loss according to at least one selected from the group consisting of the first unsupervised loss, the second unsupervised loss and the third unsupervised loss.

For example, after the first unsupervised loss, the second unsupervised loss and the third unsupervised loss are obtained through the above steps, the target unsupervised loss may be obtained through one or more of them, for example, weighted calculation is performed on the first unsupervised loss, the second unsupervised loss and the third unsupervised loss to obtain the target unsupervised loss, and a specific weighting coefficient may be set as required, which will not be further elaborated here.

FIG. 10 is a schematic diagram of a process for acquiring a target unsupervised loss provided by an embodiment of the present disclosure. As shown in FIG. 10, for example, the unlabeled sample image is input into the first teacher network, the second teacher network and the student semantic segmentation model, respectively; then, on the one hand, the first feature map output by the decoder of the first teacher network and the second feature map output by the decoder of the student semantic segmentation model are obtained, and the second unsupervised loss is obtained according to the first feature map and the second feature map; on the other hand, the second unlabeled segmentation map output by the second teacher network and the second prediction result output by the student semantic segmentation model are obtained, and the third unsupervised loss is obtained according to the second unlabeled segmentation map and the second prediction result; further, based on the first unlabeled segmentation map output by the first teacher network, the second unlabeled segmentation map output by the second teacher network and the second prediction result output by the student semantic segmentation model, the first unsupervised loss is obtained; and finally, weighted fusion is performed on the first unsupervised loss, the second unsupervised loss and the third unsupervised loss to obtain the target unsupervised loss.

S210: performing weighted fusion on the target supervised loss and the target unsupervised loss to obtain an output loss, and performing reverse gradient propagation based on the output loss to adjust network parameters of the student semantic segmentation model, so as to obtain the target semantic segmentation model.

Here, S210 is a step of generating the output loss and training the student semantic segmentation model based on the output loss, which has been introduced in the embodiment shown in FIG. 2. For details, please refer to the related introduction in S1033 corresponding to the embodiment shown in FIG. 2, which will not be repeated here.

Corresponding to the semantic segmentation model training method in the above embodiment, FIG. 11 is a structural block diagram of a semantic segmentation model training apparatus provided by an embodiment of the present disclosure. For convenience of explanation, only parts related to the embodiment of the present disclosure are shown. Referring to FIG. 11, the semantic segmentation model training apparatus 3 includes:
an acquisition module 31, configured to acquire a teacher semantic segmentation model that is pre-trained, the teacher semantic segmentation model including a first teacher network and a second teacher network, the first teacher network having structural characteristics of low depth and high width, and the second teacher network having structural characteristics of high depth and low width;
a processing module 32, configured to process a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network; and
a training module 33, configured to train a student semantic segmentation model that is lightweight according to the sample image, the first segmentation map and the second segmentation map, so as to obtain a target semantic segmentation model.

In one embodiment of the present disclosure, a depth-to-width ratio coefficient of the first teacher network is less than or equal to a first threshold, a depth-to-width ratio coefficient of the second teacher network is greater than or equal to a second threshold, the first threshold is less than the second threshold, and the depth-to-width ratio coefficient represents a ratio of a number of network layers to a number of network output channels.

In one embodiment of the present disclosure, the sample image includes a labeled sample image and an unlabeled sample image, the first segmentation map includes a first labeled segmentation map generated by the labeled sample image and a first unlabeled segmentation map generated by the unlabeled sample image, and the second segmentation map includes a second labeled segmentation map generated by the labeled sample image and a second unlabeled segmentation map generated by the unlabeled sample image; and the training module 33 is specifically configured to obtain a target supervised loss according to the labeled sample image, the first labeled segmentation map and the second labeled segmentation map; obtain a target unsupervised loss according to the unlabeled sample image, the first unlabeled segmentation map and the second unlabeled segmentation map; and perform weighted fusion on the target supervised loss and the target unsupervised loss to obtain an output loss, and perform reverse gradient propagation based on the output loss to adjust network parameters of the student semantic segmentation model, so as to obtain the target semantic segmentation model.

In one embodiment of the present disclosure, the training module 33, when obtaining the target supervised loss according to the labeled sample image, the first labeled segmentation map and the second labeled segmentation map, is specifically configured to: process the labeled sample image based on the student semantic segmentation model to obtain a first prediction result; obtain a first supervised loss based on labeling information of the labeled sample image and the first prediction result, the first supervised loss representing a difference between the labeling information and the first prediction result; obtain a second supervised loss based on the first labeled segmentation map, the second labeled segmentation map and the first prediction result, the second supervised loss representing a pixel-level consistency difference of the first segmentation map and the second segmentation map relative to the first prediction result; and obtain the target supervised loss according to the first supervised loss and the second supervised loss.

In one embodiment of the present disclosure, the training module 33, when obtaining the target unsupervised loss according to the unlabeled sample image, the first unlabeled segmentation map and the second unlabeled segmentation map, is specifically configured to: process the unlabeled sample image based on the student semantic segmentation model to obtain a second prediction result; obtain a first unsupervised loss based on the first unlabeled segmentation map, the second unlabeled segmentation map and the second prediction result, the first unsupervised loss representing a pixel-level consistency difference between the first unlabeled segmentation map and the second unlabeled segmentation map relative to the second prediction result; and obtain the target unsupervised loss according to the first unsupervised loss.

In one embodiment of the present disclosure, the processing module 32, is further configured to: acquire a first feature map of the unlabeled sample image output by a decoder of the first teacher network and a second feature map of the unlabeled sample image output by a decoder of the student semantic segmentation model; and the training module 33 is further configured to obtain a second unsupervised loss according to the first feature map and the second feature map, the second unsupervised loss representing a difference of a regional texture correlation of the second prediction result relative to a regional texture correlation of the first unlabeled segmentation map; and the training module 33, when obtaining the target unsupervised loss according to the first unsupervised loss, is specifically configured to: obtain the target unsupervised loss according to the first unsupervised loss and the second unsupervised loss.

In one embodiment of the present disclosure, the training module 33, when obtaining the second unsupervised loss according to the first feature map and the second feature map, is specifically configured to: map the first feature map into a first feature vector set, and map the second feature map into a second feature vector set, the first feature vector set representing an evaluation of region-level contents of the unlabeled sample image by the first teacher network, and the second feature vector set representing an evaluation of region-level contents of the unlabeled sample image by the student semantic segmentation model; obtain a first autocorrelation matrix and a second autocorrelation matrix according to the first feature vector set and the second feature vector set, the first autocorrelation matrix representing a correlation among region-level contents corresponding to the first feature vector set, and the second autocorrelation matrix representing a correlation among region-level contents corresponding to the second feature vector set; and obtain the second unsupervised loss according to a difference between the first autocorrelation matrix and the second autocorrelation matrix.

In one embodiment of the present disclosure, the training module 33 is further configured to: obtain a third unsupervised loss based on the second unlabeled segmentation map and the second prediction result, the third unsupervised loss representing a difference of a global semantic category corresponding to the second prediction result relative to a global semantic category corresponding to the second unlabeled segmentation map; and the training module 33, when obtaining the target unsupervised loss according to the first unsupervised loss, is specifically configured to: obtain the target unsupervised loss according to the first unsupervised loss and the third unsupervised loss.

In one embodiment of the present disclosure, the training module 33, when obtaining the third unsupervised loss based on the second unlabeled segmentation map and the second prediction result, is specifically configured to: acquire a first global semantic vector corresponding to the second unlabeled segmentation map and a second global semantic vector corresponding to the second prediction result, the first global semantic vector representing a number and a semantic category of objects segmented from the second unlabeled segmentation map, and the second global semantic vector representing a number and a semantic category of objects segmented from the second prediction result; and obtain the third unsupervised loss according to a difference between the first global semantic vector and the second global semantic vector.

The acquisition module 31, the processing module 32, and the training module 33 are connected in sequence. The semantic segmentation model training apparatus 3 provided by this embodiment can be used to implement the technical scheme of the above-mentioned method embodiment, of which implementation principle and technical effectiveness are similar to those of the method, which will not be repeated here.

FIG. 12 is a structural schematic diagram of an electronic device provided by an embodiment of the present disclosure. As shown in FIG. 12, the electronic device 4 includes:
a processor 401 and a memory 402 communicating with the processor 401;
in which the memory 402 stores computer-executed instructions; and
the processor 401 executes the computer-executed instructions stored in the memory 402, so as to implement the semantic segmentation model training method in the embodiments shown in FIG. 2-FIG. 10.

Alternatively, the processor 401 and the memory 402 are connected by a bus 403.

For details, please refer to the related descriptions and effects corresponding to the steps in the embodiments shown in FIG. 2-FIG. 10, which will not be repeated here.

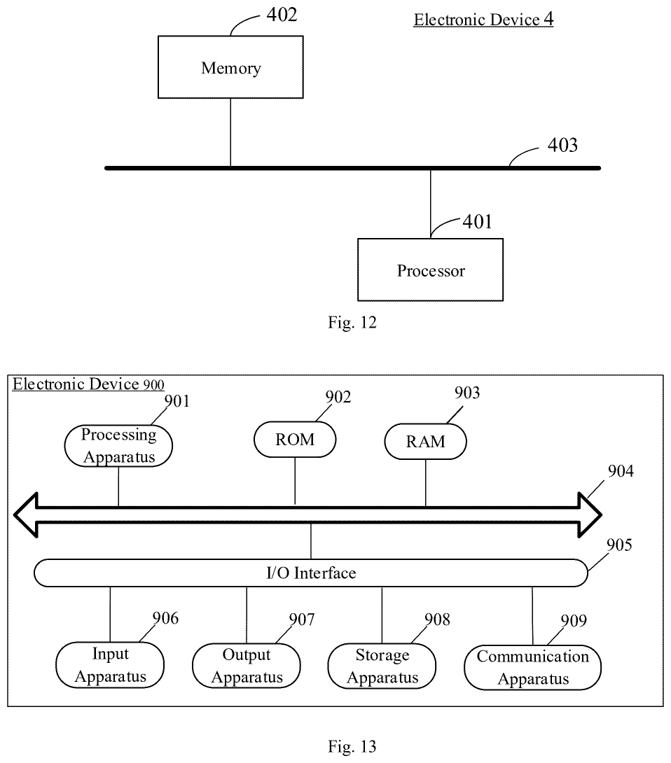

Referring to FIG. 13, FIG. 13 illustrates a schematic structural diagram of an electronic device 900 suitable for implementing the embodiments of the present disclosure. The electronic device 900 may be a terminal device or a server. The terminal device may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital Television (TV), a desktop computer, or the like. The electronic device illustrated in FIG. 13 is merely an example, and should not pose any limitation to the functions and the range of use of the embodiments of the present disclosure.

As illustrated in FIG. 13, the electronic device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected through a bus 904. An input/output (I/O) interface 905 is also connected to the bus 904.

Usually, the following apparatuses may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 13 illustrates the electronic device 900 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a computer-readable medium. The computer program includes program code for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an crasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the method shown in the above-mentioned embodiments.

The computer program code for performing the operations of the present disclosure may be written in one or more programming languages or a combination thereof. The above-mentioned programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions. The units involved in the embodiments of the present disclosure may be implemented in software or hardware. Among them, the name of the unit does not constitute a limitation of the unit itself under certain circumstances. For example, the first acquisition unit can also be described as “the unit for acquiring at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In a first aspect, according to one or more embodiments of the present disclosure, a semantic segmentation model training method is provided, including:
acquiring a teacher semantic segmentation model that is pre-trained, the teacher semantic segmentation model including a first teacher network and a second teacher network, the first teacher network having structural characteristics of low depth and high width, and the second teacher network having structural characteristics of high depth and low width; processing a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network; and training a student semantic segmentation model that is lightweight according to the sample image, the first segmentation map and the second segmentation map, so as to obtain a target semantic segmentation model.

According to one or more embodiments of the present disclosure, a depth-to-width ratio coefficient of the first teacher network is less than or equal to a first threshold, a depth-to-width ratio coefficient of the second teacher network is greater than or equal to a second threshold, the first threshold is less than the second threshold, and the depth-to-width ratio coefficient represents a ratio of a number of network layers to a number of network output channels.

According to one or more embodiments of the present disclosure, the sample image includes a labeled sample image and an unlabeled sample image, the first segmentation map includes a first labeled segmentation map generated by the labeled sample image and a first unlabeled segmentation map generated by the unlabeled sample image, and the second segmentation map includes a second labeled segmentation map generated by the labeled sample image and a second unlabeled segmentation map generated by the unlabeled sample image; and the training the student semantic segmentation model that is lightweight according to the sample image, the first segmentation map and the second segmentation map, so as to obtain the target semantic segmentation model includes: obtaining a target supervised loss according to the labeled sample image, the first labeled segmentation map and the second labeled segmentation map; obtaining a target unsupervised loss according to the unlabeled sample image, the first unlabeled segmentation map and the second unlabeled segmentation map; and performing weighted fusion on the target supervised loss and the target unsupervised loss to obtain an output loss, and performing reverse gradient propagation based on the output loss to adjust network parameters of the student semantic segmentation model, so as to obtain the target semantic segmentation model.

According to one or more embodiments of the present disclosure, the obtaining the target supervised loss according to the labeled sample image, the first labeled segmentation map and the second labeled segmentation map includes: processing the labeled sample image based on the student semantic segmentation model to obtain a first prediction result; obtaining a first supervised loss based on labeling information of the labeled sample image and the first prediction result, the first supervised loss representing a difference between the labeling information and the first prediction result; obtaining a second supervised loss based on the first labeled segmentation map, the second labeled segmentation map and the first prediction result, the second supervised loss representing a pixel-level consistency difference of the first segmentation map and the second segmentation map relative to the first prediction result; and obtaining the target supervised loss according to the first supervised loss and the second supervised loss.

According to one or more embodiments of the present disclosure, the obtaining the target unsupervised loss according to the unlabeled sample image, the first unlabeled segmentation map and the second unlabeled segmentation map includes: processing the unlabeled sample image based on the student semantic segmentation model to obtain a second prediction result; obtaining a first unsupervised loss based on the first unlabeled segmentation map, the second unlabeled segmentation map and the second prediction result, the first unsupervised loss representing a pixel-level consistency difference between the first unlabeled segmentation map and the second unlabeled segmentation map relative to the second prediction result; and obtaining the target unsupervised loss according to the first unsupervised loss.

According to one or more embodiments of the present disclosure, the method further including: acquiring a first feature map of the unlabeled sample image output by a decoder of the first teacher network and a second feature map of the unlabeled sample image output by a decoder of the student semantic segmentation model; and obtaining a second unsupervised loss according to the first feature map and the second feature map, the second unsupervised loss representing a difference of a regional texture correlation of the second prediction result relative to a regional texture correlation of the first unlabeled segmentation map; and in which the obtaining the target unsupervised loss according to the first unsupervised loss includes: obtaining the target unsupervised loss according to the first unsupervised loss and the second unsupervised loss.

According to one or more embodiments of the present disclosure, the obtaining the second unsupervised loss according to the first feature map and the second feature map includes: mapping the first feature map into a first feature vector set, and mapping the second feature map into a second feature vector set, the first feature vector set representing an evaluation of region-level contents of the unlabeled sample image by the first teacher network, and the second feature vector set representing an evaluation of region-level contents of the unlabeled sample image by the student semantic segmentation model; obtaining a first autocorrelation matrix and a second autocorrelation matrix according to the first feature vector set and the second feature vector set, the first autocorrelation matrix representing a correlation among region-level contents corresponding to the first feature vector set, and the second autocorrelation matrix representing a correlation among region-level contents corresponding to the second feature vector set; and obtaining the second unsupervised loss according to a difference between the first autocorrelation matrix and the second autocorrelation matrix.

According to one or more embodiments of the present disclosure, the method further including: obtaining a third unsupervised loss based on the second unlabeled segmentation map and the second prediction result, the third unsupervised loss representing a difference of a global semantic category corresponding to the second prediction result relative to a global semantic category corresponding to the second unlabeled segmentation map; and in which the obtaining the target unsupervised loss according to the first unsupervised loss includes: obtaining the target unsupervised loss according to the first unsupervised loss and the third unsupervised loss.

According to one or more embodiments of the present disclosure, the obtaining the third unsupervised loss based on the second unlabeled segmentation map and the second prediction result includes: acquiring a first global semantic vector corresponding to the second unlabeled segmentation map and a second global semantic vector corresponding to the second prediction result, the first global semantic vector representing a number and a semantic category of objects segmented from the second unlabeled segmentation map, and the second global semantic vector representing a number and a semantic category of objects segmented from the second prediction result; and obtaining the third unsupervised loss according to a difference between the first global semantic vector and the second global semantic vector.

In a second aspect, according to one or more embodiments of the present disclosure, a semantic segmentation model training apparatus is provided, including:
an acquisition module, configured to acquire a teacher semantic segmentation model that is pre-trained, the teacher semantic segmentation model including a first teacher network and a second teacher network, the first teacher network having structural characteristics of low depth and high width, and the second teacher network having structural characteristics of high depth and low width;
a processing module, configured to process a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network; and
a training module, configured to train a student semantic segmentation model that is lightweight according to the sample image, the first segmentation map and the second segmentation map, so as to obtain a target semantic segmentation model.

According to one or more embodiments of the present disclosure, a depth-to-width ratio coefficient of the first teacher network is less than or equal to a first threshold, a depth-to-width ratio coefficient of the second teacher network is greater than or equal to a second threshold, the first threshold is less than the second threshold, and the depth-to-width ratio coefficient represents a ratio of a number of network layers to a number of network output channels.

According to one or more embodiments of the present disclosure, the sample image includes a labeled sample image and an unlabeled sample image, the first segmentation map includes a first labeled segmentation map generated by the labeled sample image and a first unlabeled segmentation map generated by the unlabeled sample image, and the second segmentation map includes a second labeled segmentation map generated by the labeled sample image and a second unlabeled segmentation map generated by the unlabeled sample image; and the training module is specifically configured to obtain a target supervised loss according to the labeled sample image, the first labeled segmentation map and the second labeled segmentation map; obtain a target unsupervised loss according to the unlabeled sample image, the first unlabeled segmentation map and the second unlabeled segmentation map; and perform weighted fusion on the target supervised loss and the target unsupervised loss to obtain an output loss, and perform reverse gradient propagation based on the output loss to adjust network parameters of the student semantic segmentation model, so as to obtain the target semantic segmentation model.

According to one or more embodiments of the present disclosure, the training modul, when obtaining the target supervised loss according to the labeled sample image, the first labeled segmentation map and the second labeled segmentation map, is specifically configured to: process the labeled sample image based on the student semantic segmentation model to obtain a first prediction result; obtain a first supervised loss based on labeling information of the labeled sample image and the first prediction result, the first supervised loss representing a difference between the labeling information and the first prediction result; obtain a second supervised loss based on the first labeled segmentation map, the second labeled segmentation map and the first prediction result, the second supervised loss representing a pixel-level consistency difference of the first segmentation map and the second segmentation map relative to the first prediction result; and obtain the target supervised loss according to the first supervised loss and the second supervised loss.

According to one or more embodiments of the present disclosure, the training module, when obtaining the target unsupervised loss according to the unlabeled sample image, the first unlabeled segmentation map and the second unlabeled segmentation map, is specifically configured to: process the unlabeled sample image based on the student semantic segmentation model to obtain a second prediction result; obtain a first unsupervised loss based on the first unlabeled segmentation map, the second unlabeled segmentation map and the second prediction result, the first unsupervised loss representing a pixel-level consistency difference between the first unlabeled segmentation map and the second unlabeled segmentation map relative to the second prediction result; and obtain the target unsupervised loss according to the first unsupervised loss.

According to one or more embodiments of the present disclosure, the processing module is further configured to: acquire a first feature map of the unlabeled sample image output by a decoder of the first teacher network and a second feature map of the unlabeled sample image output by a decoder of the student semantic segmentation model; and the training module is further configured to obtain a second unsupervised loss according to the first feature map and the second feature map, the second unsupervised loss representing a difference of a regional texture correlation of the second prediction result relative to a regional texture correlation of the first unlabeled segmentation map; and the training module, when obtaining the target unsupervised loss according to the first unsupervised loss, is specifically configured to: obtain the target unsupervised loss according to the first unsupervised loss and the second unsupervised loss.

According to one or more embodiments of the present disclosure, the training module, when obtaining the second unsupervised loss according to the first feature map and the second feature map, is specifically configured to: map the first feature map into a first feature vector set, and map the second feature map into a second feature vector set, the first feature vector set representing an evaluation of region-level contents of the unlabeled sample image by the first teacher network, and the second feature vector set representing an evaluation of region-level contents of the unlabeled sample image by the student semantic segmentation model; obtain a first autocorrelation matrix and a second autocorrelation matrix according to the first feature vector set and the second feature vector set, the first autocorrelation matrix representing a correlation among region-level contents corresponding to the first feature vector set, and the second autocorrelation matrix representing a correlation among region-level contents corresponding to the second feature vector set; and obtain the second unsupervised loss according to a difference between the first autocorrelation matrix and the second autocorrelation matrix.

According to one or more embodiments of the present disclosure, the training module is further configured to: obtain a third unsupervised loss based on the second unlabeled segmentation map and the second prediction result, the third unsupervised loss representing a difference of a global semantic category corresponding to the second prediction result relative to a global semantic category corresponding to the second unlabeled segmentation map; and the training module, when obtaining the target unsupervised loss according to the first unsupervised loss, is specifically configured to: obtain the target unsupervised loss according to the first unsupervised loss and the third unsupervised loss.

According to one or more embodiments of the present disclosure, the training module, when obtaining the third unsupervised loss based on the second unlabeled segmentation map and the second prediction result, is specifically configured to: acquire a first global semantic vector corresponding to the second unlabeled segmentation map and a second global semantic vector corresponding to the second prediction result, the first global semantic vector representing a number and a semantic category of objects segmented from the second unlabeled segmentation map, and the second global semantic vector representing a number and a semantic category of objects segmented from the second prediction result; and obtain the third unsupervised loss according to a difference between the first global semantic vector and the second global semantic vector.

In a third aspect, according to one or more embodiments of the present disclosure, an electronic device is provided, including:
a processor and a memory communicating with the processor,
in which the memory stores computer-executed instructions, and
the processor executes the computer-executed instructions stored in the memory, so as to implement the semantic segmentation model training method described in the first aspect and various possible designs of the first aspect as above.

In a fourth aspect, according to one or more embodiments of the present disclosure, a computer-readable storage medium is provided, in which computer-executed instructions are stored in the computer-readable storage medium, and when the computer-executed instructions are executed by a processor, the semantic segmentation model training method described in the first aspect and various possible designs of the first aspect as above is implemented is implemented.

In a fifth aspect, according to one or more embodiments of the present disclosure, a computer program product is provided, including computer programs, in which the computer programs, when executed by a processor, implement the semantic segmentation model training method described in the first aspect and various possible designs of the first aspect as above.

In a sixth aspect, according to one or more embodiments of the present disclosure, a computer program is provided, the computer program is used for implementing the semantic segmentation model training method described in the first aspect and various possible designs of the first aspect as above.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise. although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A semantic segmentation model training method, comprising:
acquiring a teacher semantic segmentation model that is pre-trained, the teacher semantic segmentation model comprising a first teacher network and a second teacher network, the first teacher network having structural characteristics of low depth and high width, and the second teacher network having structural characteristics of high depth and low width;
processing a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network; and
training a student semantic segmentation model that is lightweight according to the sample image, the first segmentation map and the second segmentation map, so as to obtain a target semantic segmentation model.

2. The method according to claim 1, wherein a depth-to-width ratio coefficient of the first teacher network is less than or equal to a first threshold, a depth-to-width ratio coefficient of the second teacher network is greater than or equal to a second threshold, the first threshold is less than the second threshold, and the depth-to-width ratio coefficient represents a ratio of a number of network layers to a number of network output channels.

3. The method according to claim 1, wherein the sample image comprises a labeled sample image and an unlabeled sample image, the first segmentation map comprises a first labeled segmentation map generated by the labeled sample image and a first unlabeled segmentation map generated by the unlabeled sample image, and the second segmentation map comprises a second labeled segmentation map generated by the labeled sample image and a second unlabeled segmentation map generated by the unlabeled sample image; and
the training the student semantic segmentation model that is lightweight according to the sample image, the first segmentation map and the second segmentation map, so as to obtain the target semantic segmentation model comprises:
obtaining a target supervised loss according to the labeled sample image, the first labeled segmentation map and the second labeled segmentation map;
obtaining a target unsupervised loss according to the unlabeled sample image, the first unlabeled segmentation map and the second unlabeled segmentation map; and
performing weighted fusion on the target supervised loss and the target unsupervised loss to obtain an output loss, and performing reverse gradient propagation based on the output loss to adjust network parameters of the student semantic segmentation model, so as to obtain the target semantic segmentation model.

4. The method according to claim 3, wherein the obtaining the target supervised loss according to the labeled sample image, the first labeled segmentation map and the second labeled segmentation map comprises:
processing the labeled sample image based on the student semantic segmentation model to obtain a first prediction result;
obtaining a first supervised loss based on labeling information of the labeled sample image and the first prediction result, the first supervised loss representing a difference between the labeling information and the first prediction result;
obtaining a second supervised loss based on the first labeled segmentation map, the second labeled segmentation map and the first prediction result, the second supervised loss representing a pixel-level consistency difference of the first segmentation map and the second segmentation map relative to the first prediction result; and
obtaining the target supervised loss according to the first supervised loss and the second supervised loss.

5. The method according to claim 3, wherein the obtaining the target unsupervised loss according to the unlabeled sample image, the first unlabeled segmentation map and the second unlabeled segmentation map comprises:
processing the unlabeled sample image based on the student semantic segmentation model to obtain a second prediction result;
obtaining a first unsupervised loss based on the first unlabeled segmentation map, the second unlabeled segmentation map and the second prediction result, the first unsupervised loss representing a pixel-level consistency difference between the first unlabeled segmentation map and the second unlabeled segmentation map relative to the second prediction result; and
obtaining the target unsupervised loss according to the first unsupervised loss.

6. The method according to claim 5, further comprising:
acquiring a first feature map of the unlabeled sample image output by a decoder of the first teacher network and a second feature map of the unlabeled sample image output by a decoder of the student semantic segmentation model; and
obtaining a second unsupervised loss according to the first feature map and the second feature map, the second unsupervised loss representing a difference of a regional texture correlation of the second prediction result relative to a regional texture correlation of the first unlabeled segmentation map; and
wherein the obtaining the target unsupervised loss according to the first unsupervised loss comprises:
obtaining the target unsupervised loss according to the first unsupervised loss and the second unsupervised loss.

7. The method according to claim 6, wherein the obtaining the second unsupervised loss according to the first feature map and the second feature map comprises:
mapping the first feature map into a first feature vector set, and mapping the second feature map into a second feature vector set, the first feature vector set representing an evaluation of region-level contents of the unlabeled sample image by the first teacher network, and the second feature vector set representing an evaluation of region-level contents of the unlabeled sample image by the student semantic segmentation model;
obtaining a first autocorrelation matrix and a second autocorrelation matrix according to the first feature vector set and the second feature vector set, the first autocorrelation matrix representing a correlation among region-level contents corresponding to the first feature vector set, and the second autocorrelation matrix representing a correlation among region-level contents corresponding to the second feature vector set; and
obtaining the second unsupervised loss according to a difference between the first autocorrelation matrix and the second autocorrelation matrix.

8. The method according to claim 5, further comprising:
obtaining a third unsupervised loss based on the second unlabeled segmentation map and the second prediction result, the third unsupervised loss representing a difference of a global semantic category corresponding to the second prediction result relative to a global semantic category corresponding to the second unlabeled segmentation map; and
wherein the obtaining the target unsupervised loss according to the first unsupervised loss comprises:
obtaining the target unsupervised loss according to the first unsupervised loss and the third unsupervised loss.

9. The method according to claim 8, wherein the obtaining the third unsupervised loss based on the second unlabeled segmentation map and the second prediction result comprises:
acquiring a first global semantic vector corresponding to the second unlabeled segmentation map and a second global semantic vector corresponding to the second prediction result, the first global semantic vector representing a number and a semantic category of objects segmented from the second unlabeled segmentation map, and the second global semantic vector representing a number and a semantic category of objects segmented from the second prediction result; and
obtaining the third unsupervised loss according to a difference between the first global semantic vector and the second global semantic vector.

10. (canceled)

11. An electronic device, comprising a processor and a memory communicating with the processor, wherein:
the memory stores computer-executed instructions, and
the processor executes the computer-executed instructions stored in the memory, so as to implement a semantic segmentation model training method, which comprises:
acquiring a teacher semantic segmentation model that is pre-trained, the teacher semantic segmentation model comprising a first teacher network and a second teacher network, the first teacher network having structural characteristics of low depth and high width, and the second teacher network having structural characteristics of high depth and low width;
processing a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network; and
training a student semantic segmentation model that is lightweight according to the sample image, the first segmentation map and the second segmentation map, so as to obtain a target semantic segmentation model.

12. A computer-readable storage medium, wherein computer-executed instructions are stored in the computer-readable storage medium, and when the computer-executed instructions are executed by a processor, a semantic segmentation model training method is implemented, wherein the method comprises:
acquiring a teacher semantic segmentation model that is pre-trained, the teacher semantic segmentation model comprising a first teacher network and a second teacher network, the first teacher network having structural characteristics of low depth and high width, and the second teacher network having structural characteristics of high depth and low width;
processing a sample image based on the teacher semantic segmentation model to obtain a first segmentation map and a second segmentation map, the first segmentation map being a result of semantic segmentation of the sample image by the first teacher network, and the second segmentation map being a result of semantic segmentation of the sample image by the second teacher network; and
training a student semantic segmentation model that is lightweight according to the sample image, the first segmentation map and the second segmentation map, so as to obtain a target semantic segmentation model.

13-14. (canceled)

15. The method according to claim 2, wherein the sample image comprises a labeled sample image and an unlabeled sample image, the first segmentation map comprises a first labeled segmentation map generated by the labeled sample image and a first unlabeled segmentation map generated by the unlabeled sample image, and the second segmentation map comprises a second labeled segmentation map generated by the labeled sample image and a second unlabeled segmentation map generated by the unlabeled sample image; and
the training the student semantic segmentation model that is lightweight according to the sample image, the first segmentation map and the second segmentation map, so as to obtain the target semantic segmentation model comprises:
obtaining a target supervised loss according to the labeled sample image, the first labeled segmentation map and the second labeled segmentation map;
obtaining a target unsupervised loss according to the unlabeled sample image, the first unlabeled segmentation map and the second unlabeled segmentation map; and
performing weighted fusion on the target supervised loss and the target unsupervised loss to obtain an output loss, and performing reverse gradient propagation based on the output loss to adjust network parameters of the student semantic segmentation model, so as to obtain the target semantic segmentation model.

16. The method according to claim 4, wherein the obtaining the target unsupervised loss according to the unlabeled sample image, the first unlabeled segmentation map and the second unlabeled segmentation map comprises:
processing the unlabeled sample image based on the student semantic segmentation model to obtain a second prediction result;
obtaining a first unsupervised loss based on the first unlabeled segmentation map, the second unlabeled segmentation map and the second prediction result, the first unsupervised loss representing a pixel-level consistency difference between the first unlabeled segmentation map and the second unlabeled segmentation map relative to the second prediction result; and
obtaining the target unsupervised loss according to the first unsupervised loss.

17. The electronic device according to claim 11, wherein a depth-to-width ratio coefficient of the first teacher network is less than or equal to a first threshold, a depth-to-width ratio coefficient of the second teacher network is greater than or equal to a second threshold, the first threshold is less than the second threshold, and the depth-to-width ratio coefficient represents a ratio of a number of network layers to a number of network output channels.

18. The electronic device according to claim 11, wherein the sample image comprises a labeled sample image and an unlabeled sample image, the first segmentation map comprises a first labeled segmentation map generated by the labeled sample image and a first unlabeled segmentation map generated by the unlabeled sample image, and the second segmentation map comprises a second labeled segmentation map generated by the labeled sample image and a second unlabeled segmentation map generated by the unlabeled sample image; and
the training the student semantic segmentation model that is lightweight according to the sample image, the first segmentation map and the second segmentation map, so as to obtain the target semantic segmentation model comprises:
obtaining a target supervised loss according to the labeled sample image, the first labeled segmentation map and the second labeled segmentation map;
obtaining a target unsupervised loss according to the unlabeled sample image, the first unlabeled segmentation map and the second unlabeled segmentation map; and
performing weighted fusion on the target supervised loss and the target unsupervised loss to obtain an output loss, and performing reverse gradient propagation based on the output loss to adjust network parameters of the student semantic segmentation model, so as to obtain the target semantic segmentation model.

19. The electronic device according to claim 18, wherein the obtaining the target supervised loss according to the labeled sample image, the first labeled segmentation map and the second labeled segmentation map comprises:
processing the labeled sample image based on the student semantic segmentation model to obtain a first prediction result;
obtaining a first supervised loss based on labeling information of the labeled sample image and the first prediction result, the first supervised loss representing a difference between the labeling information and the first prediction result;
obtaining a second supervised loss based on the first labeled segmentation map, the second labeled segmentation map and the first prediction result, the second supervised loss representing a pixel-level consistency difference of the first segmentation map and the second segmentation map relative to the first prediction result; and
obtaining the target supervised loss according to the first supervised loss and the second supervised loss.

20. The electronic device according to claim 18, wherein the obtaining the target unsupervised loss according to the unlabeled sample image, the first unlabeled segmentation map and the second unlabeled segmentation map comprises:
processing the unlabeled sample image based on the student semantic segmentation model to obtain a second prediction result;
obtaining a first unsupervised loss based on the first unlabeled segmentation map, the second unlabeled segmentation map and the second prediction result, the first unsupervised loss representing a pixel-level consistency difference between the first unlabeled segmentation map and the second unlabeled segmentation map relative to the second prediction result; and
obtaining the target unsupervised loss according to the first unsupervised loss.

21. The electronic device according to claim 20, wherein the method further comprises:
acquiring a first feature map of the unlabeled sample image output by a decoder of the first teacher network and a second feature map of the unlabeled sample image output by a decoder of the student semantic segmentation model; and
obtaining a second unsupervised loss according to the first feature map and the second feature map, the second unsupervised loss representing a difference of a regional texture correlation of the second prediction result relative to a regional texture correlation of the first unlabeled segmentation map; and
wherein the obtaining the target unsupervised loss according to the first unsupervised loss comprises:
obtaining the target unsupervised loss according to the first unsupervised loss and the second unsupervised loss.

22. The electronic device according to claim 21, wherein the obtaining the second unsupervised loss according to the first feature map and the second feature map comprises:
mapping the first feature map into a first feature vector set, and mapping the second feature map into a second feature vector set, the first feature vector set representing an evaluation of region-level contents of the unlabeled sample image by the first teacher network, and the second feature vector set representing an evaluation of region-level contents of the unlabeled sample image by the student semantic segmentation model;
obtaining a first autocorrelation matrix and a second autocorrelation matrix according to the first feature vector set and the second feature vector set, the first autocorrelation matrix representing a correlation among region-level contents corresponding to the first feature vector set, and the second autocorrelation matrix representing a correlation among region-level contents corresponding to the second feature vector set; and
obtaining the second unsupervised loss according to a difference between the first autocorrelation matrix and the second autocorrelation matrix.

23. The electronic device according to claim 18, wherein the method further comprises:
obtaining a third unsupervised loss based on the second unlabeled segmentation map and the second prediction result, the third unsupervised loss representing a difference of a global semantic category corresponding to the second prediction result relative to a global semantic category corresponding to the second unlabeled segmentation map; and
wherein the obtaining the target unsupervised loss according to the first unsupervised loss comprises:
obtaining the target unsupervised loss according to the first unsupervised loss and the third unsupervised loss.
